(19) United States
(12) Patent Application Publication
(10) Pub. No.: US 2007/0089069 A1
(43) Pub. Date: Apr. 19, 2007

(54) APPARATUS AND METHODS OF DISPLAYING MULTIPLE MENUS

(75) Inventors: Kuan-Hong Hsieh, Shenzhen (CN); Han-Che Wang, Shenzhen (CN); Xiao-Guang Li, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,398

(22) Filed: Aug. 3, 2006

(30) Foreign Application Priority Data
Oct. 14, 2005 (CN) 200510100373.7

(51) Int. Cl. G09G 5/00

(52) U.S. Cl. 715/810; 345/173; 715/833

(57) ABSTRACT

A display apparatus and methods for displaying multiple menus are provided. In one embodiment, the display apparatus includes a screen and a frame connecting to the screen. The screen has a first menu region and a second menu region each displaying a menu therein. The menu in the second menu region is a child menu of a menu option displayed in a selection area of the first menu region. The frame has a first touch strip and a second touch strip. Each touch strip corresponds to one of the menu regions, and allows one to select a desired menu option to perform an associated function.

### TECHNICAL FIELD

The present invention relates to a display apparatus and display methods therefor, and particularly to a display apparatus and methods of displaying multiple menus.

### GENERAL BACKGROUND

Generally, a display apparatus is a device to visually output information including texts and graphics on a screen. It is widely and increasingly used in electronic devices. A first conventional display apparatus includes a screen to display data (i.e., an image) thereon, and a frame to support the screen. The frame is further disposed a plurality of mechanical function buttons thereon to actuate any desired function. The more functions the display apparatus has, the more mechanical function buttons the frame is disposed thereon. Therefore, the frame is designed as large as possible to hold the mechanical function buttons. As a result, a volume of the display apparatus as a whole becomes larger, and an overall appearance of the whole display apparatus looks untidy.

A second conventional display apparatus adopts a touch screen instead of mechanical buttons. The touch screen using graphical user interface (GUI) displays on the display screen thereof buttons, allowing a user to touch by finger or the like for making a selection. However, by directly touching the display screen, the touch screen thereupon is easily scratched or damaged.

Therefore, there is a need for an improved display apparatus and touch-based display method therefore that can overcome the above-mentioned problems.

### SUMMARY

In one aspect of the present invention, a touch-based display apparatus is provided. The display apparatus is capable of displaying multiple menus. The display apparatus includes a screen and a frame. The screen has a first menu region and a second menu region. Each menu region displays a menu therein. The menu in the first menu region is a child menu of a menu option of the menu in the first menu region. The frame connects to the screen and has a first touch strip and a second touch strip. Each touch strip corresponds to one of the menu regions, and allows one to select a desired menu options to perform an associated function therewith.

In another aspect of the present invention, a touch-based method enabling a display apparatus to display multiple menus is also provided, wherein the display apparatus has a screen and a frame connecting to the screen, the screen having a first menu region and a second menu region, and the frame having a first touch strip corresponding to the first menu region and a second touch strip corresponding to the second menu region. The method includes the steps of: (a) hiding a subset of menu options displayed in the first menu region and replacing the subset of the displayed menu options by another a hidden subset of menu options and displaying a child menu of the menu option which moves into a selection area of the first menu region in the second menu region, in response to a plurality of sensing signals from the first touch strip; (c) hiding a subset of menu options displayed in the second menu region and replacing the subset of the displayed menu options by another a hidden subset of menu options, in response to a plurality of sensing signals from the second touch strip; (d) displaying a parent menu of the menu currently displayed in the first menu region in the first menu region and simultaneously displaying a child menu of the menu option displayed in the selection area in the second menu region, in response to a sensing signal from the first touch strip; and (e) performing a function associated with a selected menu option, in response to a sensing signal from the second touch strip.

Other advantages and novel features will be drawn from the following detailed description with reference to the attached drawings, in which:

### BRIEF DESCRIPTION OF DRAWINGS

FIG. 1 is an exemplary schematic diagram of a touch-based display apparatus enabling to display multiple menus in accordance with a preferred embodiment of the present invention, the display apparatus including a screen and a frame, the frame having a first touch strip and a second touch strip thereof;

FIG. 2 is a block diagram representing a hardware infrastructure of a sensing signal processing circuit for a touch sensitive unit beneath the touch strips of FIG. 1 with the signal processing circuit connecting to a processing unit;

FIGS. 3A-3C illustrate a menu structure having multiple menus displayed in a first menu region and a second menu region of the screen of FIG. 1 in accordance with a preferred embodiment of the present invention, each menu region corresponding to a touch strip of FIG. 1;

FIG. 4 is a flowchart of a preferred touch-based method for enabling a display apparatus of FIG. 1 to display multiple menus in accordance with a preferred embodiment of the present invention;

FIG. 5 is a flowchart of a preferred method of implementing one step of FIG. 4, namely controlling menu options displayed in the first menu region; and

FIG. 6 is a flowchart of a preferred method of implementing one step of FIG. 4, namely controlling menu options displayed in the second menu region.

### DETAILED DESCRIPTION

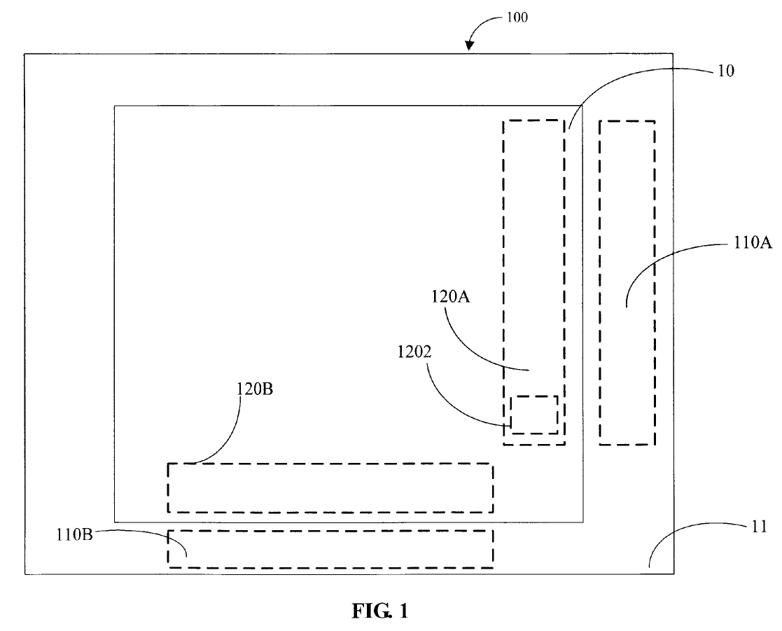

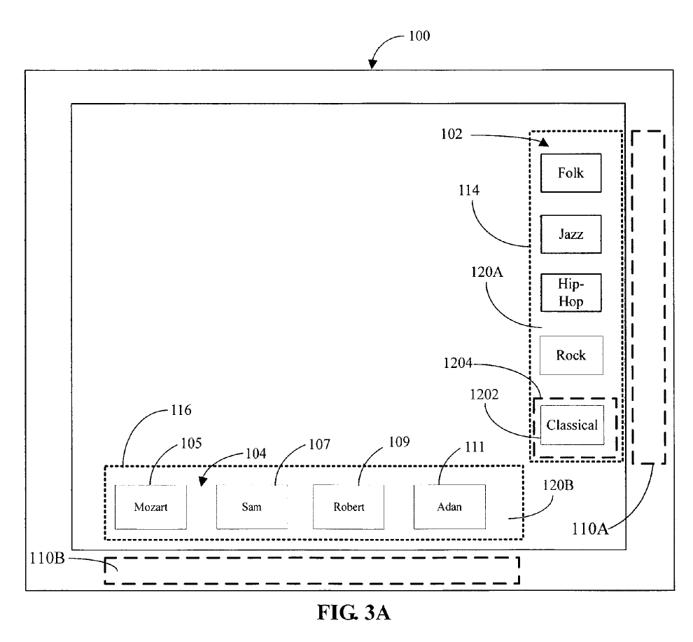

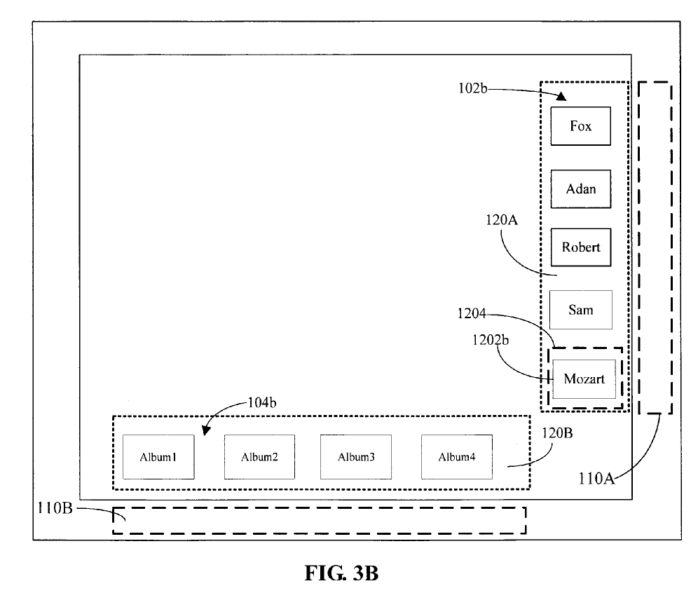

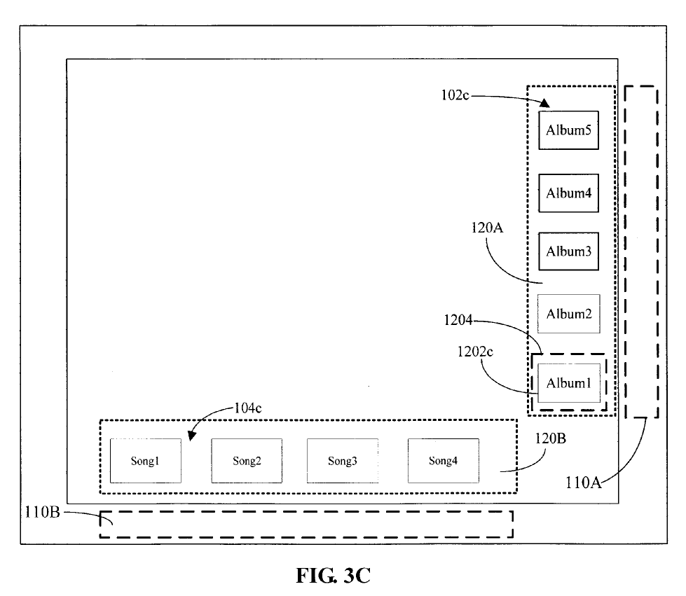

Referring to FIG. 1 and FIG. 3, a touch-based display apparatus 100 in accordance with a preferred embodiment of the present invention is shown. The display apparatus 100 includes a screen 10 and a frame 11. The screen 10 has a first menu region 120A and a second menu region 120B for displaying menu options of a corresponding menu. A first menu subset 102 and a second menu subset 104 can be displayed in the first menu region 120A and the second menu region 120B respectively therein. The first menu subset 102 and the second menu subset 104 can each further be a child menu subset of a parent menu option, i.e., each being a sub-menu of a higher hierarchy menu. Alternatively, each can be an independent menu subset. Each of the first menu subset 102 and the second menu subset 104 has one or more corresponding menu options, at least some of which are displayed on the screen 10. One or more of the menu options for each of the first menu subset 102 and the second menu subset 104 may not be displayed initially due to a limitation of space of the screen 10, moreover, they are displayable on the screen 10 as described in details later.

Each menu option may be displayed in a form of an icon. For example, the second menu subset 104 has a plurality of menu options or icons 105, 107, 109, and 111. Each icon may have a corresponding graphical label. For instance, icon 105 has a corresponding graphical label 105a. The corresponding graphical label can be a word, a symbol, a sign, a figure, a photo, a number, an indicator, or any combination of them. For example, in the embodiment as shown in FIG. 3A, the icon 105 has a corresponding graphical label 105a “Mozart”. Each icon can be in a form of a geometrical shape such as a square, a rectangle, a triangle, a circle, an ellipse, or any desired geometrical shape at a designer's choice. For example, in the embodiment as shown in FIG. 3A, the icon 105 is in the form of a rectangle.

The icons can be identical shape-wise or size-wise, or different. For example, in the embodiment as shown in FIG. 3A, the menu options or icons of the first menu subset 102 or the second menu subset 104 are substantially identical in size. Furthermore, the menu options or icons of the first menu subset 102 and the second menu subset 104 are arranged on the screen 10 to be respectively within a contour line 114 and 116. The contour lines 114 and 116 can be in the form of an open configuration or a closed configuration. For example, the contour lines 114 and 116 can take a form of a rectangle, an ellipse, a circle, and so on. The contour lines 114 and 116 can also take different forms. For the benefit of readers of this discourse and by way of example, in the embodiment as shown in FIG. 3A, the contour lines 114 and 116 have the identical form of a rectangle. Moreover, the contour lines 114 and 116 can be identical size-wise or different. For example, in the embodiment as shown in FIG. 3A, the contour lines 114 and 116 are identical size-wise so that the first menu region 120A and the second menu region 120B are substantially equal to each other size wise. In addition, the contour line 114 and 116 can be visible (displayed) or invisible (not displayed) to a viewer. In one embodiment as shown in FIG. 3A, a menu option or icon 1202 of the first menu subset 102, as discussed in additional details below, establishes a relationship between the first menu subset 102 and the second menu subset 104 in which the second menu subset 104 constitutes a child menu subset of a parent menu option, namely, the icon 1202 in the first menu region 100.

Furthermore, corresponding to the first menu region 100 and the second menu region 102, the frame 11 provides a first touch strip 110A and a second touch strip 110B thereon for being selectable by contact to perform a selected function associated with the menu options displayed in the first menu region 120A and the second menu region 120B, respectively.

In one embodiment of the present invention, a first browse operation is inputted by a stroke on the first touch strip 110A. The first browse operation controls a selection of a desired menu option or icon of the menu options or icons corresponding the first menu region 120A. That is, the first browse operation rotates or moves the desired menu option into a selection area 1204 and further hides a subset of the currently displayed menu options out of the first menu region 120A until a hidden menu subset containing the desired menu option rotates or moves into the first menu region 120A, thereby displaying the child menu subset of the selected or desired menu option in second menu region 120B.

Alternatively, a second browse operation is inputted by a stroke on the second touch strip 110B. The second browse operation controls a selection of a desired menu option or icon of the menu options or icons corresponding the second menu region 120B. That is, the second browse operation hides a subset of currently displayed menu options corresponding the second menu region 120B and displays a hidden menu subset of menu options corresponding the second menu region 120B. When a desired menu option of the second menu region 120B appears in the second menu region 120B, a select operation activates or performs the function associated with the desired menu option such as, for example, displaying the child menu subset of the desired menu option, executing a particular operation associated by the desired menu option, etc. The select operation is inputted by a touch on a corresponding location of the second touch strip 110B.

In addition, when the first menu subset 102 and the second menu subset 104 are respectively displayed in the first menu region 120A and the second menu region 120B, a back operation is operable to display the menu subsets containing the parent menu option of the menu options currently displayed in the menu regions. That is, the first menu region 120A displays the menu subset containing the parent menu option of the first menu subset 102 currently displayed thereon, and similarly the second menu region 120B displays the menu subset containing the parent menu option of the second menu subset 104 currently displayed thereon, namely the menu subset containing the parent menu option displayed in the selection area 1204. The back operation is inputted by a touch on the first touch strip 110A. However, when the first menu subset 102 currently displayed in the first menu region 120A is a root menu subset, the first menu subset 102 and the second menu subset 104 retain the same configuration as currently displayed in the first menu region 120A and the second menu region 120B without changing.

In order to provide a friendly and easy user interface, each touch strip is designed to correspond to a menu region aligned with it, that is, the first touch strip 110A and the second touch strip 110B corresponds to the first menu region 120A and the second menu region 120B respectively. Preferably, a length of each touch strip is configured to correspond to a length of the corresponding menu region. Furthermore, each touch strip has a plurality of touch sensitive units (not shown) beneath thereof. Each touch sensitive unit is configured to essentially map to a menu option of the menus. That is, each touch sensitive unit is configured to perform a function associated with the menu option. Moreover, each touch sensitive unit includes a sensing signal processing circuit 112 (described in more detail below) for generating sensing signals to perform the function associated with the menu option in response to a contact on a corresponding location of the touch strip. Each touch sensitive unit is configured beneath the touch strip and is further assigned a coordinate for identification.

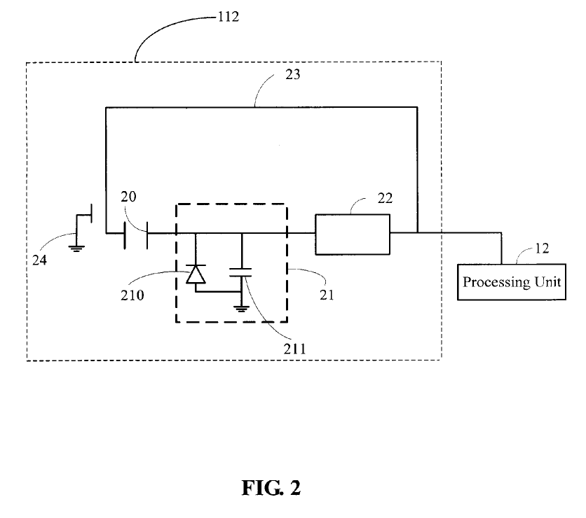

The display apparatus further includes a processing unit 12 as shown in FIG. 2. Among other things, the processing unit 12 receives and processes the sensing signals from the touch sensitive units beneath the touch strips according to assigned coordinates therewith, and performs corresponding functions. For example, in response to a plurality of sensing signals from the first touch strip 110A while the first menu 102 subset and the second menu subset 104 are displayed, the processing unit 12 hides a subset of the menu options displayed in the first menu region 120A and replaces the subset of the displayed menu options with the hidden subset of menu options, and further displays the child menu subset of the desired menu option which rotates or moves into the selection area 1204. That is, the processing unit 12 displays a plurality of menu options of the child menu subset, namely, icon 105 with a graphical label “Mozart”, icon 107 with a graphical label “Sam”, icon 109 with a graphical label “Robert”, and icon 11 with a graphical label “Adan”, in the second menu region 120B, which are corresponding to the displayed menu option or icon 1202 with a graphical label “Classical” in the selection area 1204 of the screen 10.

In response to a single sensing signal from the first touch strip 110A while the first menu subset 102 and the second menu subset 104 are displayed, the processing unit 12 actualizes the back operation.

In response to a plurality of sensing signals from the second touch strip 110B while the first menu subset 102 and the second menu subset 104 are displayed, the processing unit 12 actualizes the second browse operation.

In response to a single sensing signal from the second touch strip 110B while the first menu subset 102 and the second menu subset 104 are displayed, the processing unit 12 actualizes the selection operation. In addition, when the selected menu option has the child menu subset, the processing unit 12 displays the child menu subset of the selected menu option in the second menu region 120B, and simultaneously displays the second menu subset 104 containing the selected menu option in the first menu region 120A. For example, in the embodiment as shown in FIG. 3B, the processing unit 12 signals to display menu options of the child menu subset, namely, icon105b with a graphical label “Album1”, icon 107b with a graphical label “Album2”, icon 109b with a graphical label “Album3”, and icon 111b with a graphical label “Album4”. Icons 105b, 107b, 109b, and 111b are corresponding to the child menu subset of displayed menu option or icon 105 with the graphical label “Mozart”. The processing unit 12 further simultaneously signals to display the menu options or icons including icon 105 with the graphical label “Mozart” in the first menu region 120A, wherein icon 105 is displayed in the selection area 1204.

FIG. 2 shows a block diagram r of a sensing signal processing circuit for the touch sensitive unit 112 beneath the touch strips of FIG. 1 according to one embodiment of the present invention, wherein the sensing signal processing circuit 112 is in communication with the processing unit 12. The sensing signal processing circuit 112 has an antenna 20, a clamping circuit 21, a detector 22, a feedback line 23, and a grounding line 24. The antenna 20 is electrically coupled to the clamping circuit 21, which itself is electrically coupled to an input end of the detector 22. An output end of the detector 22 is respectively electrically coupled to the processing unit 12 and one end of the feedback line 23. The feedback line 23 forms a positive feedback circuit with the antenna 21. The grounding line 24, which takes the form of a space between two adjacent touch sensitive units, is for spacing the touch sensitive units therebetween.

It is known that the human body is electrically charged with noise and static signals. Therefore, when a user contacts or touches at least one of the first and second touch strips, at least some of the noise and static signals of the user with a desired signal may be received by the antenna 20. The antenna 20 transmits the received noise and static signals to the clamping circuit 21. However, the static electrical signals may cause interference to normal operation of the detector 22, and may even fry the detector 22. In addition, a strong noise may adversely influence a resulting sensing signal for the processing unit 12; that is, the sensitivity of the touch sensitive unit may be diminished, and the quality of the resulting sensing signal may be negatively impacted. Accordingly, the clamping circuit 21 is adapted for eliminating the static signals and for reducing the noise, thus improving the sensitivity accuracy of the touch sensitive unit.

The clamping circuit 21 in one embodiment of the present invention includes a diode 210, and a capacitor 211. The cathode of the diode 210 is electrically coupled to the antenna 20, while the anode is electrically coupled to ground. Upon receiving the noise and static signals with a desired signal, the diode 210 filters out the static signals to ground so as to avoid frying the detector 22, and reducing the noise influencing to the capacitor 211. The capacitor 211 further leaks a portion of the reduced noise to ground. Thus the reduced noise is further weakened, thereby obtaining a more accurate sensitivity.

The detector 22 has a high input impedance, so as to easily detect the desired signal with the reduced and weakened noise received from the input end of the detector 22. The detector 22 then converts the desired signal with the reduced and weakened noise into digital signals, namely the sensing signals, and transmits the sensing signals through the output end of the detector 22 to the processing unit 12 to perform corresponding controls. Furthermore, because the feedback line 23 forms a positive feedback circuit with the antenna 20, the noise generated as the user touches the edge of the touch sensitive unit is filtered, thereby further improving the sensitivity accuracy of the touch sensitive unit.

FIGS. 3A-3C illustrate a series of menus having different menu options that can be displayed in menu regions 120A and 120B of the screen 10 of the touch-based apparatus 100 as shown in FIG. 1 in accordance with a preferred embodiment of the present invention. In this exemplary embodiment, contents of the menu options provide desired information related to music, and only four menus are illustrated therein. However, either the contents of the menu options or the number of the menus are not to be construed as being limited thereto.

Each menu region is capable of displaying different parts of the information in different display states. For example, referring to FIG. 3A, where namely a first display state of the screen 10 is shown, the first menu region 120A displays the first menu subset102 providing information related to music styles with menu options or icons having corresponding graphical labels “Folk”, “Jazz”, “Hip-Hop”, “Rock”, “Classical”, . . . , respectively, and the second menu region 120B displays the second menu subset 104 or the child menu subset of a desired music style menu option of the first menu subset 102 such as, for example, menu option or icon with the graphical label “Classical”, the child menu subset 104 providing information related to classical music singers with menu options or icons having corresponding graphical labels “Mozart”, “Sam”, “Robert”, “Adan”, and so on.

Referring to FIG. 3B, where namely a second display state of the screen 10 is shown, the first menu region 120A displays a first menu subset 102b providing information related to classical music singers, which contents have been displayed as the second menu subset 104 or the child menu subset in the first display state, and the second menu region 120B displays a second menu subset 104b or a child menu subset of a desired music singer menu option of the first menu subset 102b such as, for example, menu option or icon 1202b with a graphical label “Mozart”, the child menu subset 104b providing information related to one classical music singer Mozart's music albums with menu options or icons having corresponding graphical labels “Album1”, “Album2”, “Album3”, and “Album4”, and so on.

Referring to FIG. 3C, where namely a third display state of the screen 10 is shown, the first menu region 120A displays a first menu subset 102c providing information related to music albums of one classical music singer Mozart, which contents have been displayed as the second menu subset 104b or the child menu subset in the second display state, and the second menu region 120B displays a second menu 104c or a child menu subset of a desired music album menu option of the first menu 102c such as, for example, menu option or icon 1202c with a graphical label “Album1”, the child menu subset 104c providing information related to specific music names in “Album1” with menu options or icons having corresponding graphical labels “Song1”, “Song2”, “Song3”, “Song4”, and so on.

In addition, in each display state, the selected or desired menu option displayed (i.e., icon 1202 “Classical”, icon 1202b “Mozart”, icon1202c “Album1”, respectively) in the selection area 1204 can be displayed in a selectable mode for example, such as a flashing mode.

Accordingly, because touch strips are used instead of function buttons for performing functions, the frame 11 can retain its neatness, regardless of how many functions the display apparatus 100 has. Furthermore, since the surface areas of the touch sensitive strips can be designed in smaller sizes, the frame 11 of the display apparatus 100 thereupon can be designed in a smaller size by using a narrow configuration, whereas the screen 10 thereof can be designed in a larger size, thereby the display apparatus 100 may not only obtain a neater appearance but may also posses a larger screen for display more information. Moreover, due to the utilization of the two-dimensional touch strips and dynamic menus of the display apparatus 100, a user can easily select a desired menu option to perform the function associated therewith.

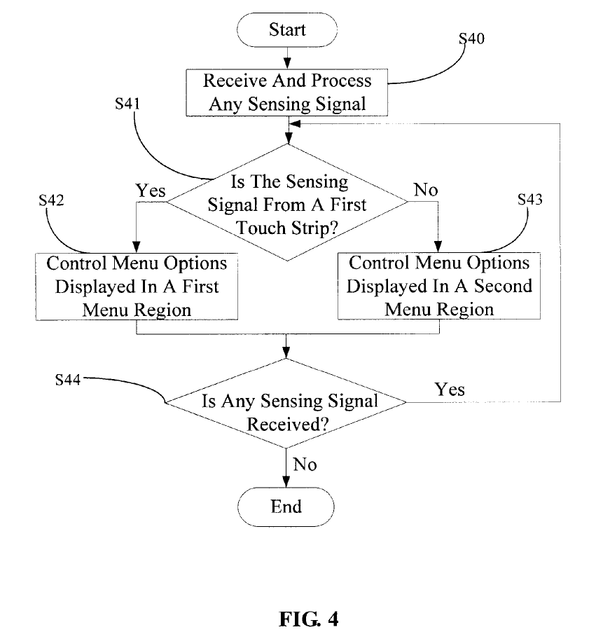

FIG. 4 is a flowchart of a method for enabling a display apparatus 100 of FIG. 1 to display multiple menus in accordance with a preferred embodiment of the present invention. In step S40, the processing unit 12 receives and processes any sensing signal from the touch sensitive units beneath the touch strips. In step S41, the processing unit 12 detects whether the sensing signal(s) is from the first touch strip 110A. If so, in step S42, the processing unit 12 controls the menu options displayed in the first menu region 120A, and the procedure goes to step S44 described below. If not, in step S43, the processing unit 12 controls the menu options displayed in the second menu region 120B, and the procedure goes to step S44 described below. In step S44, the processing unit 12 detects whether it further receives any sensing signal. If so, the procedure goes to step S41 described above, otherwise, the procedure is finished.

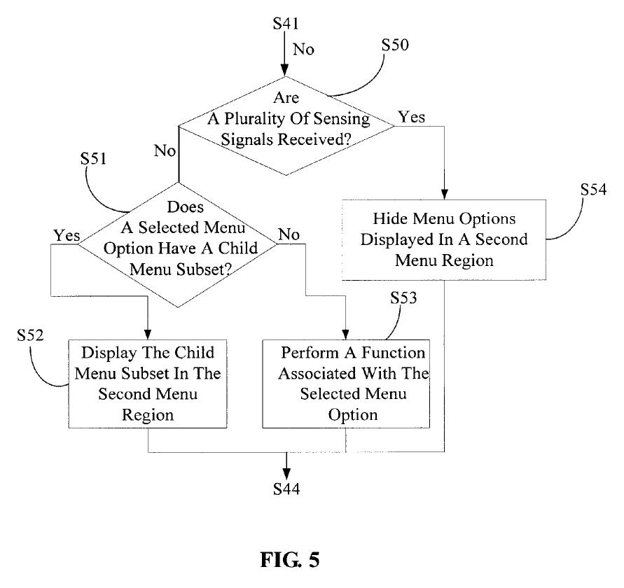

FIG. 5 is a flowchart of a method of implementing step S43 of FIG. 4. In step S50, the processing unit 12 detects whether it receives a plurality of sensing signals.

If no, namely receiving a single sensing signal, in step S51, the processing unit 12 detects whether the selected menu option in the second menu region 120B has a child menu subset. If the selected menu option has a child menu subset, in step S52, the processing unit 12 signals to display the child menu subset of the selected menu option in the second menu region 120B, and simultaneously signals to display the menu subset containing the selected menu option in the first menu region 120A, and the procedure goes to step S44 described above. If the selected menu option doesn't have a child menu subset, in step S53, the processing unit 12 signals to perform the function associated with the selected menu option, and the procedure goes to step S44 described above.

If so, namely receiving a plurality of sensing signals, in step S54, the processing unit 12 signals to hide a subset of the menu options displayed in the second menu region 120B and replaces the subset of the displayed menu options with another hidden subset of menu options, and the procedure goes to step S44 described above.

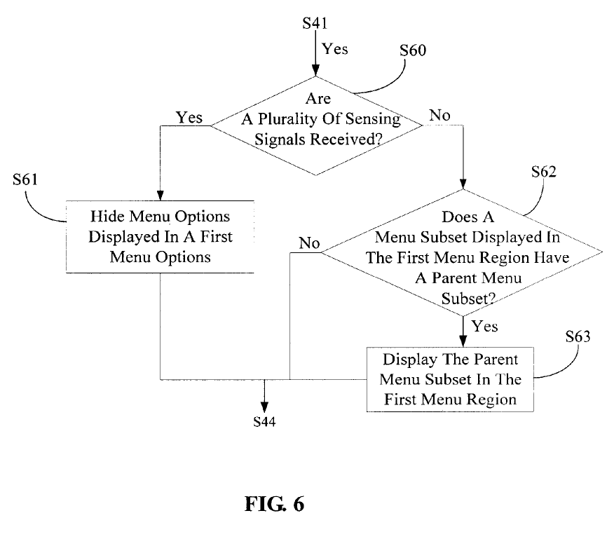

FIG. 6 is a flowchart of a method of implementing step S42 of FIG. 4. In step S60, the processing unit 12 detects whether it receives a plurality of sensing signals.

If so, namely receiving a plurality of sensing signals, in step S61, the processing unit 12 hides a subset of the menu options displayed in the first menu region 120A and replaces the subset of the displayed menu options with another hidden subset of menu options, and the procedure goes to step S44 described above.

If not, namely receiving a single sensing signal, in step S62, the processing unit 12 detects whether the menu subset displayed in the first menu region 120A has a parent menu subset. If the menu subset has a parent menu subset, in step S63, the processing unit 12 signals to display the parent menu subset in the first menu region 120A, and simultaneously signals to display the child menu of the menu option displayed in the selection area 1202 in the second menu region 120B, and the procedure goes to step S44 described above. Otherwise, the menus displayed in the menu regions retain the same as currently displayed, and the procedure goes to step S44 described above.

Accordingly, in one aspect, the present invention relates to a method for enabling a display apparatus to display a menu structure having multiple menus, {Mi}, i=1, 2, . . . , N, N being an integer greater than zero, wherein the display apparatus has a screen having a first menu region and a second menu region. In one embodiment, the method includes the steps of (a) displaying the ith menu, Mi, in the menu regions, wherein the ith menu, Mi, has a first menu and a second menu, wherein the first menu has a plurality of menu options and the second menu is a sub-menu of one of the plurality of menu options of the first menu and has a plurality of menu options, and wherein the plurality of menu options of the second menu are displayed in the second menu region and the plurality of menu options of the first menu are substantially displayed in the first menu region; (b) activating a menu option of the plurality of menu options of the second menu of the ith menu, Mi; and (c) displaying the i+1th menu, Mi+1, in the menu regions, wherein the i+1th menu, Mi+1, has a first menu and a second menu, wherein the first menu of Mi+1 has a plurality of menu options and the second menu of Mi+1 is a sub-menu of one of the plurality of menu options of the first menu of Mi+1 and has a plurality of menu options, wherein the plurality of menu options of the second menu of the i+1th menu, Mi+1, are displayed in the second menu region to replace the plurality of menu options of the second menu of the ith menu, Mi, and the plurality of menu options of the first menu of the i+1th menu, Mi+1, are substantially displayed in the first menu region to replace the plurality of menu options of the first menu of the ith menu, Mi, and wherein the first menu of the i+1th menu, Mi+1, is the second menu of the ith menu, Mi.

For the embodiment, the second menu of the ith menu, Mi, is corresponding to the at least one of the plurality of menu options of the first menu of the ith menu, Mi.

In the exemplary embodiment shown in FIGS. 3A, 3B and 3C, respectively, the 1st menu (i=1), M1 has a first menu 102 and a second menu 104. The second menu 104 of M1 is a sub-menu of menu option or icon 1202 that is one of the plurality of menu options of the first menu 102 of M1. The 2nd menu (i+1=2), M2, has a first menu 102b and a second menu 104b. The second menu 104b of M2 is a sub-menu of menu option or icon 1202b that is one of the plurality of menu options of the first menu 102b of M2. As displayed, the plurality of menu options of the second menu 104b of M2, are displayed in the second menu region 120B to replace the plurality of menu options of the second menu 104 of M1, and the plurality of menu options of the first menu 102b of M2, are substantially displayed in the first menu region 120A to replace the plurality of menu options of the first menu 102 of M1. And the first menu 102b of M2 is the second menu 104 of M1. Furthermore, the 3rd menu, M3, has a first menu 102c and a second menu 104c. The second menu 104c of M3 is a sub-menu of menu option or icon 1202c that is one of the plurality of menu options of the first menu 102c of M3.

In another aspect, the present invention relates to software stored on a computer readable medium for enabling a display apparatus to display a menu structure having multiple menus, {Mi}, i =1, 2, . . . , N, N being an integer greater than zero, wherein the display apparatus has a screen having a first menu region and a second menu region, to perform functions including: (a) displaying the ith menu, Mi, in the menu regions, wherein the ith menu, Mi, has a first menu and a second menu, wherein the first menu has a plurality of menu options and the second menu is a sub-menu of one of the plurality of menu options of the first menu and has a plurality of menu options, and wherein the plurality of menu options of the second menu are displayed in the second menu region and the plurality of menu options of the first menu are substantially displayed in the first menu region; (b) activating a menu option of the plurality of menu options of the second menu of the ith menu, Mi; and (c) displaying the i+1th menu, Mi+1, in the menu regions, wherein the i+1th menu, Mi+1, has a first menu and a second menu, wherein the first menu has a plurality of menu options and the second menu is a sub-menu of one of the plurality of menu options of the first menu and has a plurality of menu options, wherein the plurality of menu options of the second menu of the i+1th menu, Mi+1, are displayed in the second menu region to replace the plurality of menu options of the second menu of the ith menu, Mi, and the plurality of menu options of the first menu of the i+1th menu, Mi+1, are substantially displayed in the first menu region to replace the plurality of menu options of the first menu of the ith menu, Mi, and wherein the first menu of the i+1th menu, Mi+1, is the second menu of the ith menu, Mi. The software can be stored on a computer readable medium and read by a controller or processing unit 12 to perform corresponding functions.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A display apparatus capable of displaying multiple menus, the display apparatus comprising:
a screen having a first menu region and a second menu region each menu region displaying a menu therein, wherein the menu in the second menu region is a child menu of a menu option of the menu in the first menu region; and
a frame connected to the screen and having a first touch strip corresponding to the first menu region and a second touch strip corresponding to the second menu region, each touch strip being selective to perform a function associated with a menu option displayed in a corresponding menu region.

2. The apparatus according to claim 1, wherein each touch strip comprises a plurality of touch sensitive units each mapped to a menu option.

3. The apparatus according to claim 2, wherein each touch sensitive unit further comprises a sensing signal processing circuit for generating sensing signals in response to contact, and each touch sensitive unit is assigned a coordinate for identification.

4. The apparatus according to claim 3, further comprising a processing unit for processing the sensing signals and performing corresponding functions associated with the menu options.

5. The apparatus according to claim 4, wherein the processing unit is configured to hide a subset of menu options displayed in the first menu region and to replace the subset of the displayed menu options by another a hidden subset of menu options and to display a child menu of the menu option which moves into a selection area of the first menu region, in response to a stroke operation on the first touch strip.

6. The apparatus according to claim 4, wherein the processing unit is configured to display a parent menu of the menu currently displayed in the first menu region in the first menu region and simultaneously to display the child menu of the menu option displayed in the selection area in the second menu region, in response to a touch operation on the first touch strip.

7. The apparatus according to claim 4, wherein the processing unit is configured to hide a subset of menu options displayed in the second menu region and to replace the subset of the displayed menu options by another a hidden subset of menu options, in response to a stroke operation on the second touch strip.

8. The apparatus according to claim 4, wherein the processing unit is configured to display a plurality of menu options of a child menu of a selected menu option displayed in the second menu region if necessary, in response to a touch operation on the second touch strip.

9. A method for enabling a display apparatus to display multiple menus, wherein the display apparatus has a screen and a frame connected to the screen, the screen having a first menu region and a second menu region, and the frame having a first touch strip corresponding to the first menu region and a second touch strip corresponding to the second menu region, the method comprising the steps of:
hiding a subset of menu options displayed in the first menu region and replacing a subset of the displayed menu options by another a hidden subset of menu options and displaying a child menu of the menu option which moves into a selection area of the first menu region in the second menu region, in response to a plurality of sensing signals from the first touch strip;
hiding a subset of menu options displayed in the second menu region and replacing the subset of the displayed menu options by another a hidden subset of menu options, in response to a plurality of sensing signals from the second touch strip;
displaying a parent menu of the menu currently displayed in the first menu region in the first menu region and simultaneously displaying a child menu of the menu option displayed in the selection area in the second menu region, in response to a sensing signal from the first touch strip; and
performing a function associated with a selected menu option, in response to a sensing signal from the second touch strip.

10. The method according to claim 9, wherein the performing step further comprises the step of: displaying a child menu of the selected menu option if the selected menu option has the child menu.

11. The method according to claim 10, wherein the child menu is displayed in the second menu region, and the menu including the selected menu option is displayed in the first menu region.

12. A method for controlling multiple menus displayed in a display apparatus, the display apparatus has a screen and a frame connected to the screen, the screen having a first menu region and a second menu region, and the frame having a first touch strip corresponding to the first menu region and a second touch strip corresponding to the second menu region, the method comprising the steps of:
receiving an operational input;
performing a control on the menu displayed in the first menu region, if the operational input is on the first touch strip; and
performing a control on the menu displayed in the second menu region, if the operational input is on a second touch strip.

13. The method according to claim 12, wherein the step of performing a control on the menu displayed in the first menu region further comprises the steps of:
hiding a subset of menu options displayed in the first menu region and replacing the subset of the displayed menu options by another a hidden subset of menu options and displaying a child menu of the menu option which moves into a selection area of the first menu region in the second menu region, if the operational input comprises a plurality of sensing signals; and
displaying a parent menu of the menu currently displayed in the first menu region in the first menu region, if the operational input comprises a single sensing signal.

14. The method according to claim 12, wherein the step of performing a control on the menu displayed in the second menu region further comprises the steps of:
hiding a subset of menu options displayed in the second menu region and replacing the subset of the displayed menu options by another a hidden subset of menu options, if the operational input comprises a plurality of sensing signals; and
performing a function associated with a selected menu option displayed in the second menu region, if the operational input comprises a single sensing signal.

15. The method according to claim 14, wherein the performing step further comprises the step of: displaying a child menu of the selected menu option if the selected menu option has the child menu.

16. The method according to claim 15, wherein the child menu is displayed in the second menu region, and the menu including the selected menu option is displayed in the first menu region.

17. A method for enabling a display apparatus to display a menu structure having multiple menus, {Mi}, i=1, 2, . . . , N, N being an integer greater than zero, wherein the display apparatus has a screen having a first menu region and a second menu region, comprising the steps of:
(a) displaying the ith menu, Mi, in the menu regions, wherein the ith menu, Mi, has a first menu and a second menu, wherein the first menu has a plurality of menu options and the second menu is a sub-menu of one of the plurality of menu options of the first menu and has a plurality of menu options, and wherein the plurality of menu options of the second menu are displayed in the second menu region and the plurality of menu options of the first menu are substantially displayed in the first menu region;
(b) activating a menu option of the plurality of menu options of the second menu of the ith menu, Mi; and
(c) displaying the i+1th menu, Mi+1, in the menu regions, wherein the i+1th menu, Mi+1, has a first menu and a second menu, wherein the first menu has a plurality of menu options and the second menu is a sub-menu of one of the plurality of menu options of the first menu and has a plurality of menu options, wherein the plurality of menu options of the second menu of the i+1th menu, Mi+1, are displayed in the second menu region to replace the plurality of menu options of the second menu of the ith menu, Mi, and the plurality of menu options of the first menu of the i+1th menu, Mi+1, are substantially displayed in the first menu region to replace the plurality of menu options of the first menu of the ith menu, Mi, and wherein the first menu of the i+1th menu, Mi+1, is the second menu of the ith menu, Mi.

18. The method according to claim 17, wherein the second menu of the ith menu, Mi, is corresponding to the at least one of the plurality of menu options of the first menu of the ith menu, Mi.

19. Software stored on a computer readable medium for enabling a display apparatus to display a menu structure having multiple menus, {Mi}, i=1, 2, . . . , N, N being an integer greater than zero, wherein the display apparatus has a screen having a first menu region and a second menu region, to perform functions comprising:
(a) displaying the ith menu, Mi, in the menu regions, wherein the ith menu, Mi, has a first menu and a second menu, wherein the first menu has a plurality of menu options and the second menu is a sub-menu of one of the plurality of menu options of the first menu and has a plurality of menu options, and wherein the plurality of menu options of the second menu are displayed in the second menu region and the plurality of menu options of the first menu are substantially displayed in the first menu region;
(b) activating a menu option of the plurality of menu options of the second menu of the ith menu, Mi; and
(c) displaying the i+1th menu, Mi+1, in the menu regions, wherein the i+1th menu, Mi+1, has a first menu and a second menu, wherein the first menu of Mi+1 has a plurality of menu options and the second menu of Mi+1 is a sub-menu of one of the plurality of menu options of the first menu of Mi+1 and has a plurality of menu options, wherein the plurality of menu options of the second menu of the i+1th menu, Mi+1, are displayed in the second menu region to replace the plurality of menu options of the second menu of the ith menu, Mi, and the plurality of menu options of the first menu of the i+1th menu, Mi+1, are substantially displayed in the first menu region to replace the plurality of menu options of the first menu of the ith menu, Mi, and wherein the first menu of the i+1th menu, Mi+1, is the second menu of the ith menu, Mi.
